(19) United States
(12) Patent Application Publication
(10) Pub. No.: US 2004/0188963 A1
(43) Pub. Date: Sep. 30, 2004

(54) Wheeled bag carrier and equipment bag

(76) Inventor: Heather Gant, Woodstock, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/613,298

(22) Filed: Jul. 3, 2003

Related U.S. Application Data
(60) Provisional application No. 60/420,064, filed on Oct. 21, 2002.

(51) Int. Cl. B62B 1/12

(52) U.S. Cl. 280/47.24

(57) ABSTRACT

A cart for transporting a bag of equipment such as sports equipment has at least a first and second bracket made of durable and light weight tubing material in which the second bracket is telescoped into the first bracket. The first bracket has tubular legs spaced by a platform on which one end of the bag rests. Wheels are mounted at the bottom of the bracket for rolling the cart. The brackets are formed of tubular legs and the bag, resting on the platform, is attached to the legs when the legs are in an extended configuration.

### FIELD OF THE INVENTION

This invention relates to a wheeled bag carrier and an equipment bag therefor.

### BACKGROUND OF THE INVENTION

Wheeled luggage carriers have gained a great deal of popularity among travelers, especially where the luggage itself must be transported from one site to another as in, for example, airports. In those locations, moving the often heavy luggage from a parking lot to the terminal, and from the terminal to the check-in station has, in the past, placed a burden on the luggage carrier. Thus, elderly people and young children find that they lack sufficient strength to manage the heavy load involved. For this reason, wheeled luggage or luggage carriers have become quite common inasmuch as they relieve the user having to cope with overly heavy loads.

In the field of sports, wheeled golf carts have gained wide acceptance in that the heavy golf bag, when mounted on the cart, is much easier to transport, and the personal strength of the golfer is not a factor. Such carts are usually equipped with support legs which allow the cart to remain in an upright position when not being pulled or moved.

Despite the widespread use of such transporters, there is an area of activity in which there is a very real need, and which, apparently, has not been addressed. Broadly, this area is characterized by children being the luggage or load movers, such as, for example, in Little League baseball. In children's baseball (or in other sports such as midget football), the child bears the burden of transporting his equipment to and from his home to the playing field, or from the parking area for his parent's car, which often is quite a distance. The burden for a Little Leaguer generally comprises his batting helmet, his glove, his bats, and any other necessary paraphernalia. This amounts to quite a load, which is generally carried in a large duffel bag. Thus it usually falls to parents to carry the loaded bag, especially where the child is small. Even for older children the load is excessive. The parent is, most often, the child's mother, and the burden upon her of transporting the bag any considerable distance is onerous. The bag itself is quite large and, while it can usually be stored in the trunk of the car, it takes up a great deal of room.

### SUMMARY OF THE INVENTION

The present invention is a wheeled cart upon which the duffel can be placed and secured, and transported with ease over virtually any reasonable distance and/or terrain, and an equipment bag therefor.

The cart itself comprises at least two, and in the preferred embodiment, three brackets having tubular legs preferably of a light metal such as, for example, aluminum, or sturdy plastic tubing such as PVC, of successively larger interior diameters so that the smaller diameter legs can be telescope into the larger diameter legs. The lower end of the bracket having the largest diameter legs (the lower bracket) has a transversely extending platform, and at either end thereof are mounted rotatable wheels. A transverse strength member extends between the two legs of the lower bracket to maintain rigidity of the bracket and to form a support for the duffel. An intermediate bracket having legs of an outer diameter that allows them to slide easily into the legs of the lower bracket also has a transverse strength member for rigidity and bag support. The intermediate bracket has locking or positioning means to allow it to be held in place in extended position relative to the lower bracket. A third, upper bracket is similar to the intermediate bracket with its legs being slidable to the legs of the intermediate bracket, with positioning or locking means. The upper portion of the upper bracket legs are bent inwardly at the upper portion thereof to form a single handle for pushing or pulling the cart. Alternatively, the handle may simply be attached to a transverse strength member at the upper, or distal, end of the third bracket. With such a structure, the cart may be collapsed into a compact unit for storage in the trunk of a car, for example.

The duffel bag itself has a flat elongated bottom portion and at least one end having a flattened transverse portion for resting on, and being supported by, the transverse platform on the lower bracket. The top of the bag has a longitudinally extending arcuate shape, which is joined by a portion having a zipper extending the length thereof. On either side of the zipper are carrying handles for carrying the bag when it is not mounted on the cart. When mounted on the cart, the bag is held in place by the transverse platform, the transverse strength members, and by suitable attaching means such as Velcro® strips which wrap around the legs of the cart brackets. Means other than Velcro® may be used to secure the bag to the cart, although Velcro® is especially favored for its not having to be knotted.

The interior of the bag may be compartmental, such as by a shelf for the baseball glove and an elongated chamber for one or more bats, which may be kept separate by suitable septa. On the exterior side of the elongated bottom portion is provided a net bag which is adapted to contain the batting helmet. The end of the elongated flat portion remote from the transverse flat portion has hooks or other suitable holding means for hanging the bag on a fence, for example. Other types of hanging members may also be used instead of the hooks. The bag itself may have interior or exterior pockets formed therein for small items such as, for example, comb, Band-Aids, etc.

In operation, assuming the collapsed cart and the bag are transported in the trunk of a car to a parking place near the baseball diamond, the cart is first elongated and locked in that configuration, and the bag is placed thereon, supported by the transverse platform and the strength members. The bag is then attached to the cart bracket legs by the Velcro® strips. It thus becomes a simple matter to pull or push the cart to the baseball diamond with a minimum of effort, even for a small child.

The invention, as will be more fully described hereinafter, while discussed as useful for baseball, is readily adaptable to transport other types of configurations of equipment, or even luggage, as will be apparent from the following detailed description, read in conjunction with the accompanying drawings.

### BRIEF DESCRIPTION OF THE DRAWINGS

FIG. 1 is a front elevation view of the cart frame, in its operative extended configuration;

FIG. 2 is a front elevation view of the cart frame in its collapsed configuration;

FIG. 3 is a side elevation view of the operative configuration of the cart of the invention, including the frame and the equipment carrying bag;

FIG. 4 is a cross-sectional view of the detail of the invention showing one apparatus for maintaining the cart in its extended position;

FIG. 5 is a cross-sectional view of a detail of an alternative arrangement for maintaining the cart in its extended position;

FIG. 6 is a perspective view of the equipment carrying bag of the invention;

FIG. 7 is a side elevation view of the bag of the invention; and

FIG. 8 is a rear elevation view of the bag of the invention.

### DETAILED DESCRIPTION OF THE PREFERRED EMBODIMENT

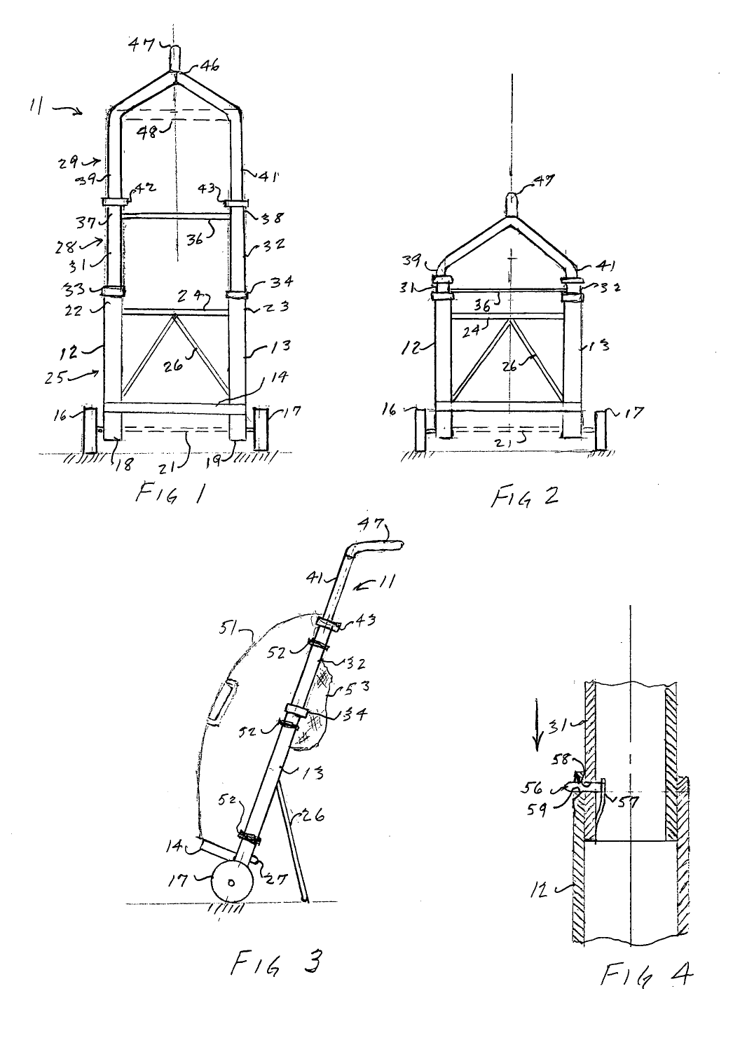

The cart frame 11 of the invention, as shown in FIG. 1, comprises a first or lower pair of spaced tubular legs 12 and 13, preferably made of a light metal such as aluminum, and having first inside diameters. Affixed at the lower end of the legs 12 and 13 and extending therebetween is a support platform 14 for supporting the duffel bag as seen in FIG. 3. First and second wheels 16 and 17 are rotatably attached at the lower ends 18,19 of legs 12 and 13, or may be rotatable on an axle 21, shown in dashed lines. Near the top ends 22 and 23 of legs 12 and 13 and extending therebetween is a strength member 24.

The combination of legs 12 and 13, platform 14, and strength member 24 forms a first or lower bracket 25. Pivotally attached to strength member 24 at approximately the center thereof is a V-shaped member 26 which is pivotable from a position against the legs 12 and 13 and held there by suitable clamping means 27 to an extended position, as shown in FIG. 3, where it forms support legs for holding the cart in an upright position when standing still.

As discussed hereinbefore, the cart of the invention, as shown in FIGS. 1, 2, and 3 has three brackets 25, 28, and 29. However, it is to be understood that two brackets or more than three brackets may be used without departure from the spirit and scope of the invention.

Bracket 28, the intermediate bracket, has a pair of tubular legs 31, 32 which have an outside diameter slightly less than the inside diameter of tubular legs 12 and 13, and are spaced to slide inwardly and outwardly (telescoping) of legs 12 and 13. Locating members 33 and 34, which may take any of a number of forms, as will be discussed hereinafter, help maintain the legs 31 and 32, and hence bracket 28, in the extended position when the cast 11 is in use. A strength member 36 extends between legs 31 and 32 near the top ends 37 and 38 thereof, completing bracket 28.

Bracket 29 has first and second tubular legs 39 and 41 having outside diameters which are slightly less than the inside diameters of legs 31 and 32, and which are spaced to slide freely within legs 31 and 32. Locating members 42 and 43 function to maintain bracket 29 in its extending position, as will be discussed more fully hereinafter. As shown in FIG. 1, legs 39 and 41 are bent to slope inwardly and joined at a junction 46, where they may be welded or otherwise affixed to each other. A handle member 47 is affixed to junction 46, either permanently or by being held in place by bolts or screws (not shown) or by other suitable attaching means. In lieu of the formation of junction 46, legs 39 and 41 may be joined by a single member 48, shown in dashed liens, which functions both as a handle and as a strength member.

The cart 11 of the invention is shown in FIG. 1 in its extended configuration, ready for use. FIG. 2 illustrates the cart 11 in its collapsed or storage configuration, which is achieved by deactivating locating members 33, 34, and 42, 43, and telescoping the brackets 25, 28, and 29 together.

FIG. 3 is a side elevation view illustrating the cart 11 in its operative configuration, with an equipment carrying bag 51 in place thereon. As will be discussed hereinafter, bag 51 is held in place on cart 11 by resting on platform 14, and by being tied or fastened by, for example, Velcro® strips 52 joined to the bracket legs, as shown or other suitable attaching devices. In addition, bag 51 has attached to the rear thereof an enlarged pocket 53 of suitable material which is intended primarily to contain a batting helmet, although other equipment may be carried therein instead, or also.

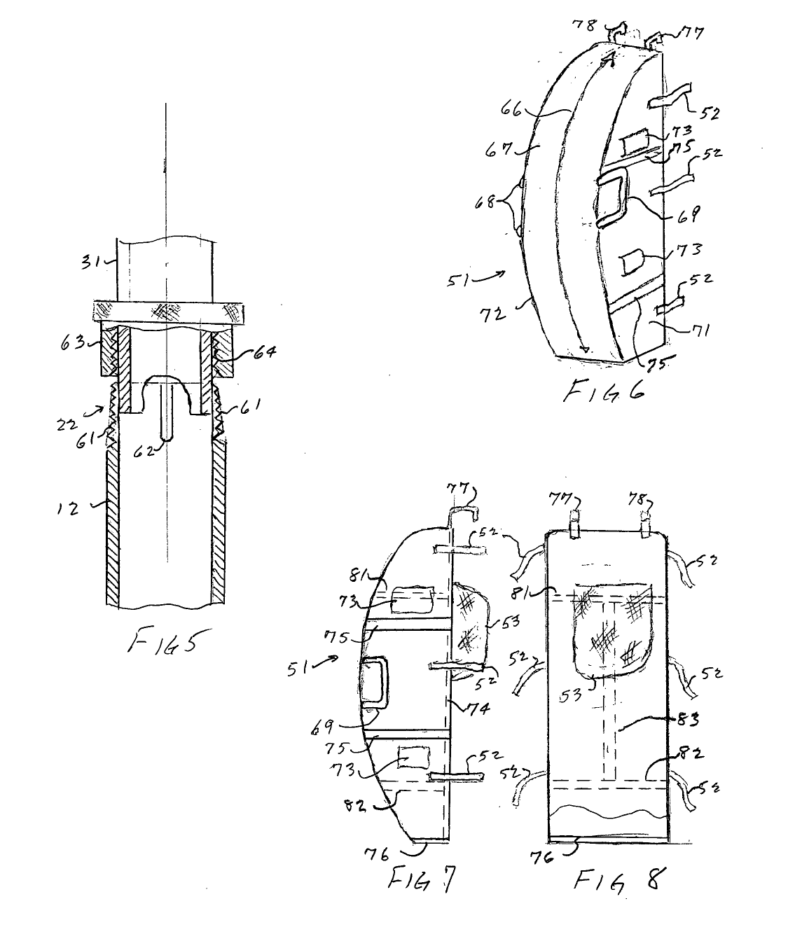

As pointed out hereinbefore, members 33, 34 and 42, 43 may take any of a number of forms that function to hold the middle bracket 28 in the extended position relative to lower bracket 25, and upper bracket 29 in the extended position relative to middle bracket 28. FIGS. 4 and 5 are partial cross-sectional views of two different configurations of the members 33, 34 and 42, 43. While both figures are shown with legs 12 and 31, it is to be understood that each of the members 33, 34, 42, and 43 may have the same construction.

In FIG. 4, a pin 56, having a leaf spring 57 bearing against its proximal end, spring 57 being affixed to the interior of leg 31 as shown, which extends through a hole 58 in leg 31 and a hole 59 in leg 12, thereby affixing leg 31 in extended position relative to leg 12.

When it is desired to collapse leg 31 into leg 12, pin 56 is pushed inward until it clears hole 59 and leg 31 is pressed in the direction of the arrow. To facilitate clearing pin 56 from hole 59, hole 59 may be countersunk, as shown to enable finger pressure on pin 56 to cause it to clear hole 59. From the construction shown in FIG. 4, it can be that when leg 31 is pulled sufficiently outward, pin 56 will encounter and pass through hole 59, thereby locking leg 51 relative to leg 12.

In the arrangement of FIG. 5, the end 22 is threaded with preferably tapered threads 61, and, further, has one or more splits 62 which impart a degree of flexibility to leg 12 at its end 22. A nut 63 surrounding leg 31 has internal threads 64 which are designed to mate with threads 61 on leg 12. As nut 63 is tightened, it exerts radial pressure on the tapered threads 61, thereby squeezing end 22 of leg 12. By means of splits 62, the actual inside diameter of leg 12 is decreased to where it firmly grips the outside diameter of leg 31, thereby affixing leg 31 relative to leg 12 in virtually any desired telescopic position. Collapse of leg 31 into leg 12 is achieved simply by the loosening of the nut 63, which eliminates the radial “squeeze”. With this arrangement, the legs 39 and 41 do not have to be hollow tubes although for reasons of weight, tubes are preferred.

FIG. 6 is a perspective view of the bag 51 showing an access zipper 66 which extends almost the entire length of the arcuate portion 67 of the bag 51. It is to be understood that other closing devices than at zipper 66 may be used, such as Velcro® straps or latches, for example. Bag 51 is preferably made of a light weight durable material such as nylon or polyester embossed PVC or other suitable material. On either side of the arcuate portion 67 at approximately the longitudinal center are handles 68 and 69 for carrying the bag 51 when it is detached from the cart. The sides 71 and 72 of the bag may have small auxiliary pockets 73 for carrying small materials such as, for example, Band-Aids or other items.

FIG. 7 is a side elevation view of the bag 51. Preferably the bag 51 has a reinforced fairly flat bottom 74, shown in dashed lines, and a reinforced fairly flat end 76 which is adapted to rest on platform 14 of the cart 11. Reinforcing strips 75 strengthens the sides of the bag 51. A pair of mounting hooks 77 and 78 are attached to the bag 51 at the end opposite the reinforced end 76 for hanging the bag 51 on a fence or other suitable structure after it has been removed from the cart. While hooks are shown, it is possible that other means of hanging the bag, all included under the generic name “hangers”, might just as easily be used. An enlarged pocket 53 of suitable mesh or netting material, such as nylon mesh, is used for holding a large piece of equipment such as a batting helmet.

The interior of bag 51 may be partitioned, as shown by the dashed lines. For example, member 81, of suitable stiff plastic material, may form a shelf for containing a glove or mitt and preventing it from falling to the bottom of the bag during transport. A similar shelf or divider 82 may create a chamber for shoes or the like. A vertical member 83 may hold one or more bats in place. Such partitioning, which may be arranged differently than that shown, serves to keep the various pieces of equipment in place within the bag instead of falling to the bottom thereof during transport.

In use, the bag 51 may be filled with the various equipment components at home, for example and placed in the trunk of the car along with the collapsed cart. At the destination, the cart is extended to its in-use configuration and the bag is then loaded thereon. The cart can then be easily rolled to the team dugout where the bag can, although not necessarily, be removed from the cart and hung up by means of hooks 77 and 78 and opened for access to the equipment, which is in the several compartments created by the partitioning. When the game is over, the process is simply reversed. Very little physical stress is involved while transporting a fairly heavy collection of equipment.

It is to be understood that the various features of the present invention might be incorporated into other types of equipment carriers, and that other modifications and/or adaptations might occur to workers in the art. All such modifications or adaptations are intended to be included herein as being within the scope of the present invention as set forth. Further, in the claims hereafter, the corresponding structures, materials, acts, and equivalents of all means or step-plus-function elements are intended to include any structure, material, or acts for performing the functions in combination with other elements as specifically claimed.

Therefore, having thus described the invention, at least the following is claimed:

1. A wheeled cart for transporting bagged equipment comprising
a first bracket member having upper and lower ends, said bracket member having first and second tubular legs, each having a first inside diameter;
first and second rotatable wheels mounted at said bottom end of said bracket;
a second bracket member having upper and lower ends and having third and fourth spaced tubular legs, the outside diameter of each of said third and fourth legs being less than the inside diameter of said first and second tubular legs, whereby said second bracket members is slidable with respect to said first bracket members when said third and fourth legs are inserted into said first and second legs; and
locating members for locating and holding said second bracket member within said first bracket member in an extended position.

2. A wheeled cart as claimed in claim 1 and further including a third bracket having upper and lower ends and having fifth and sixth spaced legs, the outside diameter of each of said fifth and sixth legs being less than the inside diameter of said third and fourth tubular legs, whereby said third bracket member is slidable with respect to said second bracket member when said fifth and sixth legs are inserted into said third and fourth legs.

3. A Wheeled cart as claimed in claim 2 wherein said fifth and six legs are tubular.

4. A wheeled cart as claimed in claim 2 and further including locating members for locating and holding said third bracket member within said second bracket member in an extended position.

5. A wheeled cart as claimed in claim 2 wherein said fifth and six legs are joined together at the top of said third bracket and a handle is attached thereto at the junction of the leg ends.

6. A wheeled cart as claimed in claim 1 wherein said first bracket has a strength member spanning the distance between said first and second legs.

7. A wheeled cart as claimed in claim 1 wherein said second bracket has a strength member spanning the distance between said third and fourth legs.

8. A wheeled cart as claimed in claim 1 wherein both said first and second brackets have strength members spanning the distance between their respective tubular legs.

9. A wheeled cart as claimed in claim 2 wherein said first, second, and third bracket members have strength members spanning the distance between their respective legs.

10. A wheeled cart as claimed in claim 6 wherein a support member is pivotally attached to said strength member.

11. A wheeled cart as claimed in claim 10 wherein said support member is substantially V-shaped with the open of the V being pivotally attached at the approximate center of said strength member.

12. A wheeled cart as claimed in claim 2 wherein said legs of each of said brackets are made of a lightweight material having sufficient strength to withstand the stresses thereon.

13. A wheeled cart as claimed in claim 12 wherein said lightweight material is aluminum.

14. A wheeled cart as claimed in claim 12 wherein said lightweight material is a plastic.

15. In combination, a collapsible wheeled cart having an extended position and an equipment carrying bag therefor, said cart having two or more brackets forming a framework for supporting said bag when said cart is in the extended position, said cart further having a platform for supporting one end of said bag;
said bag having a substantially flat end adapted to rest upon said platform and a plurality of attaching devices for securing the bag to the framework; and
said bag further having a closure means for providing access to the interior of the bag.

16. The combination as claimed in claim 15 wherein said bag is made of a lightweight durable material.

17. An equipment bag having first and second ends, a substantially flat bottom and a substantially arcuately shaped top portion;
said first end having a substantially flat reinforced portion;
said bottom having a substantially flat reinforced portion;
said arcuately shaped top portion having a closure member extending approximately the entire length thereof for accessing the interior of the bag, and first and second carrying handles on either side of said closure member.

18. An equipment bag as claimed in claim 17 wherein said bag is made of a lightweight durable material.

19. An equipment bag as claimed in claim 18 wherein said material is nylon.

20. An equipment bag as claimed in claim 19 wherein said material is a polyester embossed plastic material.

21. An equipment bag as claimed in claim 17 wherein a pocket of netting material, said pocket being adapted to hold a large piece of equipment, is mounted on the exterior side of said bottom portion of said equipment bag.

22. An equipment bag as claimed in claim 21 wherein said pocket is made of nylon mesh material.

23. An equipment bag as claimed in claim 17 wherein one or more hanger members are affixed to the reinforced bottom portion of said bag at the second end thereof.

24. An equipment bag as claimed in claim 17 wherein the interior of said bag is compartmentalized, forming chambers for differently configured equipment and maintaining the equipment in place.
